(19) United States
(12) Patent Application Publication
(10) Pub. No.: US 2005/0135785 A1
(43) Pub. Date: Jun. 23, 2005

(54) Reproducing apparatus and method and computer readable recording medium storing program for executing the method

(75) Inventors: Kwang-min Kim, Anyang-si (KR); Hyun-kwon Chung, Seoul (KR); Kil-soo Jung, Hwaseong-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/999,126

(22) Filed: Nov. 30, 2004

(30) Foreign Application Priority Data
Dec. 1, 2003 (KR) 2003-86510

(51) Int. Cl. H04N 5/783

(52) U.S. Cl. 386/69; 386/70; 386/95

(57) ABSTRACT

A reproducing apparatus and method, and a computer readable recording medium having a program for executing the method employing an extended Java Media Framework. The reproducing apparatus includes an extended Java Media Framework to control the playback of moving picture data that includes audio/video (AV) data and playback information of the AV data. The reproducing apparatus is independent of a platform such that it can be applied to various platforms in reproducing the moving picture data including the AV data and the playback information of the AV data.

### CROSS-REFERENCE TO RELATED APPLICATION

This application claims the priority of Korean Patent Application No. 2003-86510, filed on Dec. 1, 2003 in the Korean Intellectual Property Office, the disclosure of which is incorporated herein in its entirety by reference.

### BACKGROUND OF THE INVENTION

1. Field of the Invention

The present invention relates to a reproducing apparatus, and more particularly, to an apparatus and method for reproducing moving picture data including audio/video (AV) data and playback information of the AV data, and a computer readable recording medium storing a program for executing the method.

2. Description of the Related Art

FIG. 1 is a reference diagram illustrating a basic structure of moving picture data including audio/video (AV) data and playback information of the AV data according to the conventional art.

Referring to FIG. 1, the moving picture data includes the AV data, which is recording unit data, and the playback information of the AV data, which is reproducing unit data. The recording unit data may be a clip layer 120, and the reproducing unit data may be a playlist layer 110.

A clip 121 from the recording unit data includes clip AV stream data 123 and clip information data 122. The clip AV stream data 123 includes audio data, video data, and so on, and the clip information data 122 corresponds on a one-to-one basis to the clip AV stream data 123 and contains characteristic information used in recording the clip AV stream data 123.

Reproducing unit data includes information for reproducing the clip 121, and the highest order data of the reproducing unit data is called playlist data. One playlist data 111 may include a plurality of playitem data 112, and one playitem data 112 is connected to one clip information data 122 in order to reproduce one clip AV stream data 123 connected to the clip information data 122. The playlist data 111 is used as a basic reproducing unit for a specific purpose in a reproducing apparatus.

FIG. 2 is a reference diagram illustrating a detailed structure of the playlist data shown in FIG. 1 according to the conventional art.

Referring to FIG. 2, playlist data 210, which is reproducing unit data, is in a playlist file 200. The playlist file 200 includes the playlist data 210 and mark information data 230.

The playlist data 210 includes a plurality of playitem data 220. Each playitem data 220 includes a clip information file name 221, which is used for playback, a used codec name 222, a multiangle information and corresponding clip information file name 223, playback control information 224, start and end time information 225, playback attribute information 226, and so on.

FIG. 3 is a reference diagram illustrating a detailed structure of the clip data shown in FIG. 1 according to the conventional art.

Referring to FIG. 3, clip AV stream data 320 in a clip 300, which is recording unit data, includes video data 321, audio data 322, and additional data 323. The additional data 323 may include bitmap subtitle data, text-based subtitle data, and the like.

Clip information data 310 corresponds on a one-to-one basis to the AV stream data 320, and includes characteristic information used in recording corresponding AV stream data, that is, stream type information 311 of stream data in the AV stream data 320, stream coding information 312, entry point information 313 indicating a position at an arbitrary time, and sequence characteristic information 314 of the stream data.

FIG. 4 is a schematic diagram of a conventional apparatus for reproducing moving picture data.

Referring to FIG. 4, an apparatus 400 for reproducing moving picture data includes a playback control engine 410, which reads reproducing unit data and controls playback of AV stream data, a presentation engine 420, which decodes the AV stream data and displays the decoded data on a screen, a user interface controller 430, which receives a user input, and an output unit 440, which outputs video/audio data.

The playback control engine 410 receives navigation data, such as a playlist file, parses playitems arranged in steps, confirms an object and contents to be reproduced, reads clip information data included in the playitems, confirms information necessary for reproducing corresponding clip AV stream data, and provides all information necessary for reproducing the clip AV stream data to the presentation engine 420. The playback control engine 410 includes a set of functions, that is, an application program interface (API) 411, by which the above functions can be provided.

Further, the playback control engine 410 receives from the user interface controller 430 a user input generated during the playback, and properly operates based on information recorded in the reproducing unit data.

A player register 412 in the playback control engine 410 stores or reads information regarding the playback and playback control.

For example, if it is assumed that AV data has audio data in a plurality of languages, audio format information and information about what kind of audio data is in the AV stream data are included in the reproducing unit data. Language information of the audio data to be initially used is recorded in the player register 412, and the playback control engine 410 reads the audio data language information recorded in the player register 412 and controls the presentation engine 420 to read the corresponding audio data. If a user wishes to change the audio language, the user interface controller 430 receives the user's corresponding input, and the playback control engine 410 parses contents from the user interface controller 430 and controls the presentation engine 420 to reproduce the audio data in a new language based on the information recorded in the reproducing unit data.

The presentation engine 420 receives and decodes stream data of a file including the AV data according to instructions of a function, namely, a playback control function, of the playback control engine 410, and outputs the decoded data to the output unit 440.

The reproducing apparatus simply reproduces moving picture data including the reproducing unit data. That is, the reproducing apparatus can only sequentially reproduce the moving picture data from a predetermined time to a predetermined time. Accordingly, there is a demand for a higher level method of controlling the playback control engine 410 to reproduce the moving picture data according to various scenarios in an interactive mode, such as in a game or during a chatting session, as well as to sequentially reproduce the data.

An approach in this regard is a window media programming method, which is provided by Microsoft Company, used in a personal computer (PC). However, the window media programming method cannot be used without the WINDOWS operating system. Java Media Framework (JMF) based on Java language that is a programming language independent of a platform, however, can be used in various platform environments, such as a PC and a mobile phone, to provide various interface functions and reproduce media data.

FIG. 5 is a reference diagram illustrating a basic structure of a conventional JMF.

Referring to FIG. 5, a JMF 500 for reproducing media data includes a datasource 510, a JMF player 520, and a control 530.

The datasource 510 manages the lifecycle of the media data. The datasource 510 is connected to a media data source through a uniform resource identifier (URI), and transmits data to the JMF player 520 connected thereto.

The JMF player 520 reproduces the data transmitted from the datasource 510. The JMF player 520 confirms a media data type to reproduce the transmitted data, and transmits the data to an output unit, such as a speaker 540 or a monitor 550, using each decoder necessary for the data type.

The control 530 controls additional functions provided by the datasource 510 or the JMF player 520. For example, the control 530 uses a GainControl interface to control audio sound volume.

The JMF 500 supports AV data of numerous formats such as AVI, moving picture experts group (MPEG) format, MP3 format, Real Audio format, and so on, but cannot support moving picture data including AV data as recording unit data and playback information of the AV data as reproducing unit data.

Accordingly, a reproducing apparatus, which can reproduce moving picture data including AV data as recording unit data and playback information of the AV data as reproducing unit data, is demanded to work together with a JMF application easily applicable to various platforms.

### SUMMARY OF THE INVENTION

According to an aspect of the present invention, a reproducing apparatus and method, which can be applied to various platforms in reproducing moving picture data including audio/video (AV) data and playback information of the AV data, and a computer readable recording medium having a program for the executing method are provided.

According to an aspect of the present invention, there is provided a reproducing apparatus including an extended Java Media Framework to control a playback of moving picture data that includes audio/video (AV) data and playback information of the AV data.

In an aspect of the present invention, the extended Java Media Framework includes at least one of: a datasource package unit, which parses the playback information of the moving picture data and transmits the parsed playback information to a media package; the media package unit, which controls the playback of the moving picture data according to the playback information received from the datasource package; or a control package unit, which controls additional functions providable in relation to the playback of the moving picture data.

In an aspect of the present invention, the datasource package includes at least one of: a playlist class, which fetches information in a playlist; a playitem class, which fetches information in a playitem; a clipinfo class, which fetches information in a clipinfo; or a text subtitle class, which fetches information regarding a text subtitle.

In an aspect of the present invention, the media package includes at least one of: a player class, which controls the playback of the moving picture data; a manager class, which generates and manages a mediasource and player class; or a media locator class, which finds a position of a data file.

In an aspect of the present invention, the control package includes at least one of: an angle control class, which controls an angle; a subtitle control class, which controls a subtitle; an audio control class, which controls an audio; a display control class, which controls a display; a player control class, which controls a player; or a playback control class, which controls a playback.

In an aspect of the present invention, the reproducing apparatus includes a playback control engine, which controls to reproduce the moving picture data according to a control of the Java Media Framework; and a presentation engine, which receives a control of the playback control engine and reproduces the moving picture data.

According to another aspect of the present invention, there is provided a reproducing method comprising controlling a playback of moving picture data, which includes AV data and playback information of the AV data, using an extended Java Media Framework inheriting a Java Media Framework structure.

In an aspect of the present invention, the controlling of the playback includes parsing the playback information of the moving picture data; controlling the playback of the moving picture data according to the parsed playback information; and controlling additional functions providable in relation to the playback of the moving picture data.

In an aspect of the present invention, the parsing of the playback information includes at least one of: fetching information in a playlist; fetching information in a playitem; fetching information in a clipinfo; or fetching information regarding a text subtitle.

In an aspect of the present invention, the controlling of the playback of the moving picture data includes at least one of: controlling the playback of the moving picture data; generating and managing a mediasource and player class; or finding a position of a data file.

In an aspect of the present invention, the controlling of the additional functions includes at least one of: controlling an angle; controlling a subtitle; controlling an audio; controlling a display; controlling a player; or controlling a playback.

According to another aspect of the present invention, there is provided a computer readable recording medium having embodied thereon a computer program for executing a reproducing method, the method including controlling a playback of moving picture data, which includes AV data and playback information of the AV data, using an extended Java Media Framework inheriting a Java Media Framework structure.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a reference diagram illustrating a basic structure of moving picture data including audio/video (AV) data and playback information of the AV data according to the conventional art;

FIG. 2 is a reference diagram illustrating a detailed structure of playlist data shown in FIG. 1 according to the conventional art;

FIG. 3 is a reference diagram illustrating a detailed structure of clip data shown in FIG. 1 according to the conventional art;

FIG. 4 is a schematic block diagram of a conventional apparatus for reproducing moving picture data;

FIG. 5 is a reference diagram illustrating a basic structure of a conventional Java Media Framework (JMF);

FIG. 6 is a reference diagram illustrating a basic structure of an extended JMF according to an embodiment of the present invention;

FIG. 7 is a reference diagram illustrating a basic data structure of the extended JMF according to an embodiment of the present invention;

FIG. 8 is a diagram illustrating a detailed structure of the extended JMF shown in FIG. 6 according to an embodiment of the present invention;

FIG. 9 is a diagram illustrating a detailed structure of an extended datasource package shown in FIG. 8 according to an embodiment of the present invention;

FIG. 10 is a diagram illustrating a detailed structure of an extended media package shown in FIG. 8 according to an embodiment of the present invention;

FIG. 11 is a diagram illustrating a detailed structure of an extended control package shown in FIG. 8 according to an embodiment of the present invention;

FIG. 12 is a schematic block diagram of a reproducing apparatus including the extended JMF according to an embodiment of the present invention;

FIG. 13 is a flow chart of a method of reproducing moving picture data using the reproducing apparatus including the extended JMF according to an embodiment of the present invention; and

FIG. 14 is a flow chart of a method of controlling the playback of the moving picture data in the reproducing apparatus including the extended JMF according to an embodiment of the present invention.

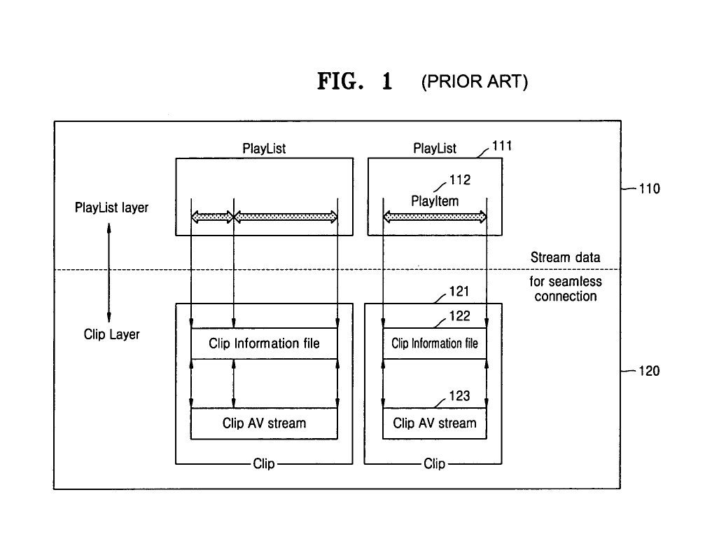

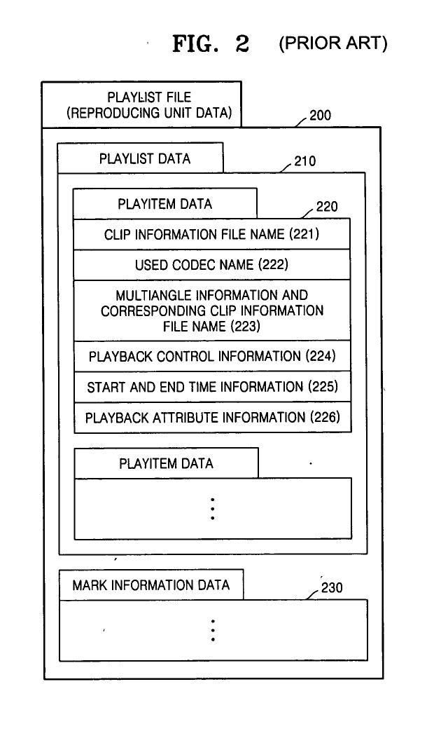

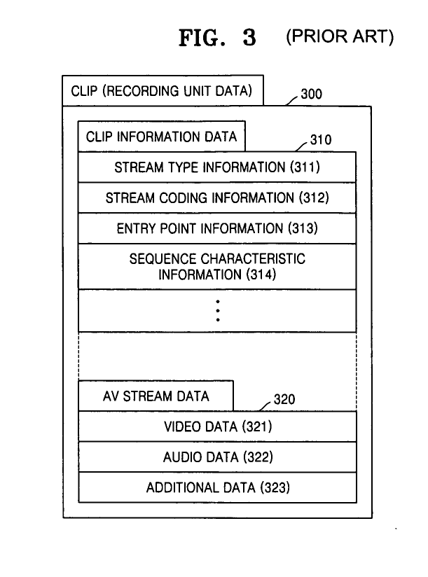

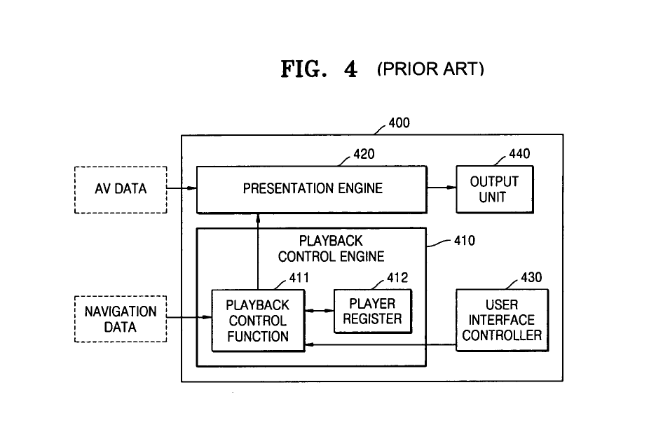

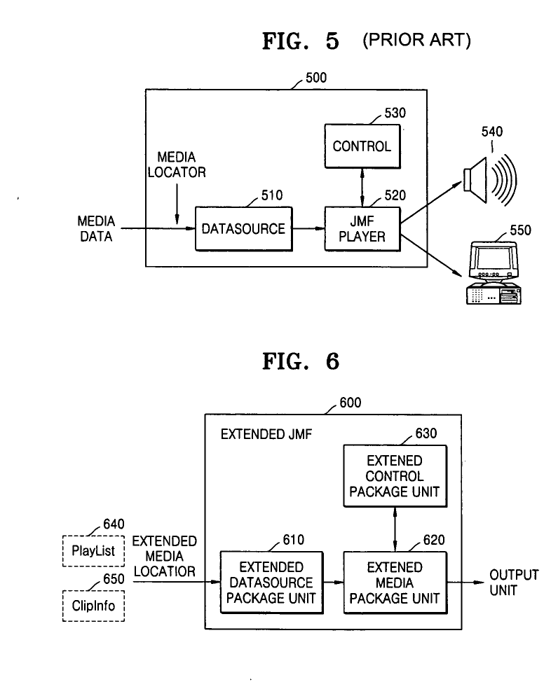

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

FIG. 6 is a reference diagram illustrating a basic structure of an extended Java Media Framework (JMF) according to an embodiment of the present invention.

Referring to FIG. 6, an extended JMF 600 includes an extended datasource package unit 610, an extended media package unit 620, and an extended control package unit 630. Each of the extended package units 610, 620, and 630 includes at least one class. The extended JMF 600 may include any combination of the package units in addition to all three being implemented together.

The extended datasource package unit 610 parses playback information of a clipinfo file 650 or a playlist file 640 of moving picture data as well as media data provided from an existing JMF, and transmits the parsed playback information to the extended media package unit 620 such that the extended media package unit 620 can reproduce clip data designated by the playlist file 640.

Reproducing unit data arranged in steps can be grouped in their own classes, such that each class includes application program interface (API) functions used to provide information in the reproducing unit data in each step to a player or a user. Examples of the API functions include a clip file name, the number of angles, an angle data file, and the like, which will be explained later in detail.

The extended media package unit 620 reproduces the moving picture data according to the playback information received from the extended datasource package unit 610. For example, the extended media package unit 620 starts a playback of the moving picture data, stops the playback, adjusts a playback speed, generates a mediasource and player class based on reproducing unit data, such as a playlist, and reads file information in a disk or a memory to find a corresponding file, which will be explained in detail later.

The extended control package unit 630 provides additional functions providable in relation to the playback of the moving picture data, which will be explained in detail later.

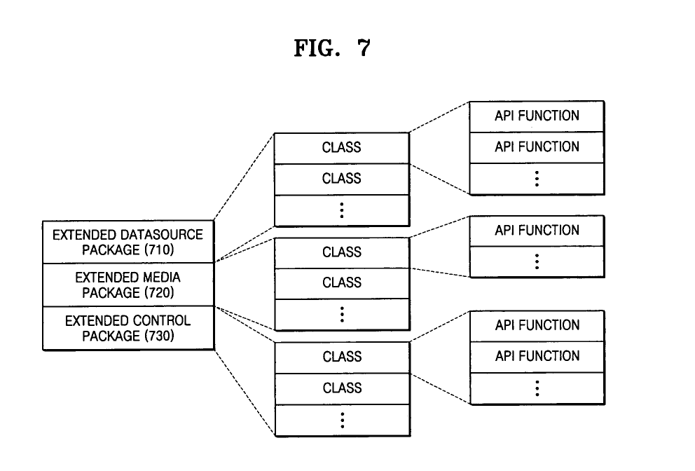

FIG. 7 is a reference diagram of a basic data structure of the extended JMF shown in FIG. 6 according to an embodiment of the present invention.

The extended JMF includes an extended datasource package 710, an extended media package 720, and an extended control package 730. Each package 710, 720 and 730 includes at least one class that provides functions executed by the package, and each class includes API functions used to perform its own functions.

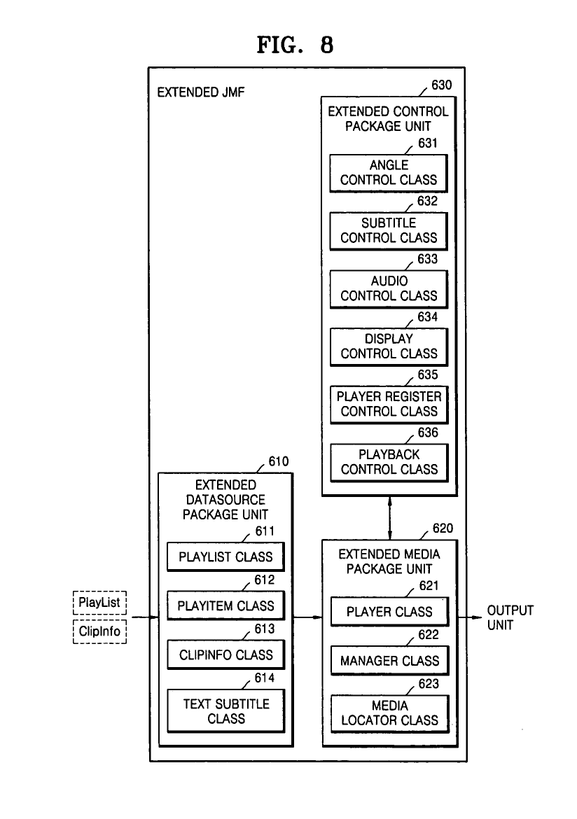

A detailed structure of the extended JMF having the above data structure will be explained with reference to FIG. 8.

FIG. 8 is a diagram of a detailed structure of the extended JMF 600 shown in FIG. 6 according to an embodiment of the present invention.

Referring to FIG. 8, an extended datasource package unit 610 includes a playlist class 611, a playitem class 612, a clipinfo class 613, and a text subtitle class 614. The extended datasource package unit 610 may include only one of the classes or any combination thereof.

The playlist class 611 fetches information in a playlist, the playitem class 612 fetches information in a playitem, the clipinfo class 613 fetches information in a clipinfo, and the text subtitle class 614 fetches information regarding a text subtitle.

The extended media package unit 620 includes a player class 621, a manager class 622, and a media locator class 623. The extended media package unit 620 may include only one of the classes or may include any combination of the classes.

The player class 621 controls the playback of the moving picture data, the manager class 622 generates a mediasource and player class, and the media locator class 623 finds a position of a data file.

The extended control package unit 630 includes an angle control class 631, a subtitle control class 632, an audio control class 633, a display control class 634, a player register control class 635, and a playback control class 636. The extended control package unit 630 may include only one of the classes or may include any combination of the classes.

The angle control class 631 controls an angle, the subtitle control class 632 controls a subtitle, the audio control class 633 controls an audio, the display control class 634 controls a display, the player register control class 635 controls a player register, and the playback control class 636 controls a playback.

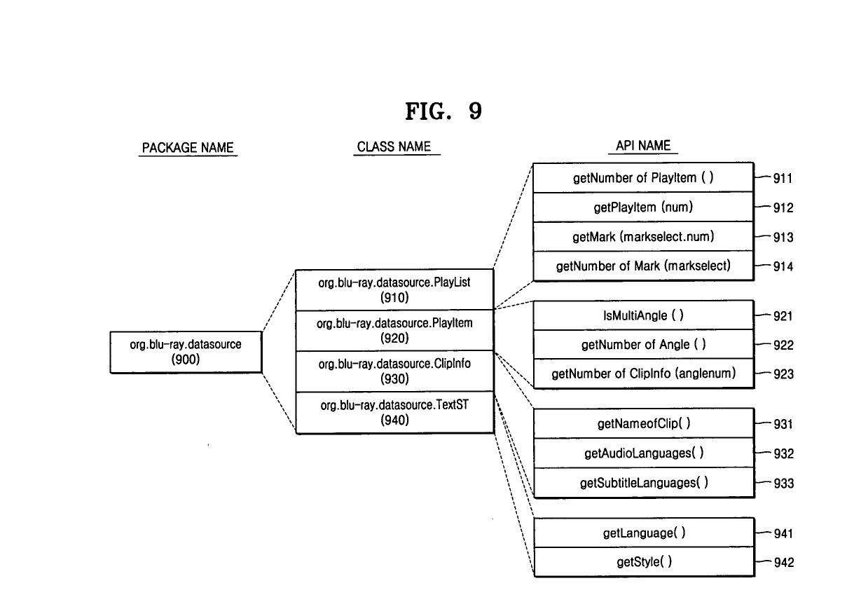

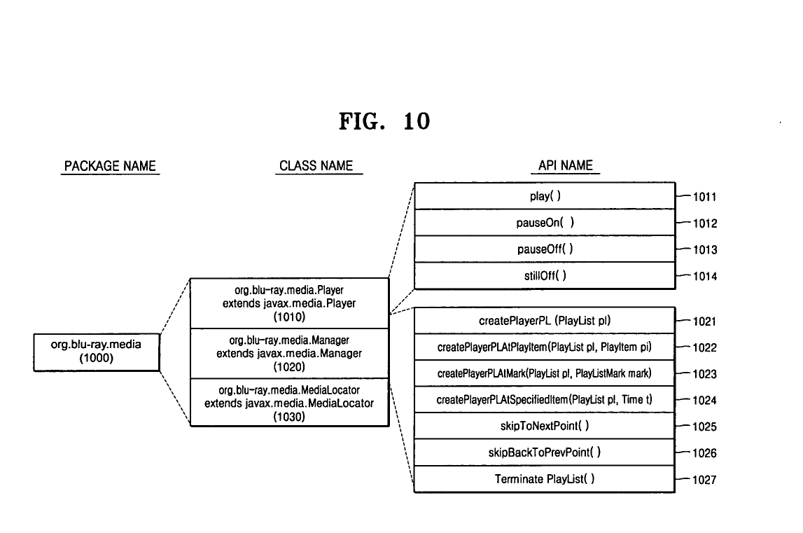

FIG. 9 is a diagram illustrating a detailed structure of the extended datasource package unit 610 shown in FIG. 8.

Referring to FIG. 9, a package name 900 of the extended datasource package is org.blu-ray.datasource, and names of classes in the extended datasource package are org.blu-ray.datasource.PlayList 910, org.blu-ray.datasource.PlayItem 920, org.blu-ray.datasource.Clipinfo 930, org.blu-ray.datasource.TextST 940.

Reproducing unit data arranged in steps can be grouped in their own classes, such that each class provides information in the reproducing unit data in each step to a player or a user.

The org.blu-ray.datasource.PlayList class 910 provides information in a playlist file to a player or a user. APIs included in the org.blu-ray.datasource.PlayList 910 class are getNumberOfPlayItem( ) 911, getplayItem(num) 912, getMark(markselect,num) 913, getNumberOfMark(markselect) 914. The functions of the APIs are defined as shown in Table 1.

TABLE 1
Class name: org.blu-ray.datasource.PlayList

| | |
|---|---|
| getNumberOfPlayItem( ); | Fetch the number of playitems in a |
| | playlist |
| getPlayItem(num); | Fetch a specific playitem in a playlist |
| getMark(markselect,num); | Fetch a specific mark in a playlist |
| getNumberOfMark(markselect); | Fetch the number of marks in a playlist |

The org.blu-ray.datasource.PlayItem class 920 provides information in a playitem file to a player or a user. APIs included in the org.blu-ray.datasource.PlayItem class 920 are IsMultiAngle( ) 921, getNumerOfAngle( ) 922, and getNameOfClipInfo(anglenum) 923, and functions of the APIs are defined as shown in Table 2.

TABLE 2
Class name: org.blu-ray.datasource.PlayItem

| | |
|---|---|
| IsMultiAngle( ); | Ascertain whether multiangles are |
| getNumerOfAngle( ); | Fetch the number of multiangles |
| getNameOfClipInfo(anglenum); | Fetch a clipinfo file name corresponding |
| | to a specific multiangle |

The org.blu-ray.datasource.ClipInfo class 930 provides information in a clipinfo file to a player or a user. APIs included in the org.blu-ray.datasource.ClipInfo class 930 are getNameOfClip( ) 931, getAudioLanguages( ) 932, and getSubtitleLanguages( ) 933, and functions of the APIs are defined as shown in Table 3.

TABLE 3
Class name: org.blu-ray.datasource.ClipInfo

| | |
|---|---|
| getNameOfClip( ); | Fetch a name of a corresponding clip file |
| getAudioLanguages( ); | Fetch a language of a current audio |
| getSubtitleLanguages( ); | Fetch a language of a current subtitle |

APIs included in the org.blu-ray.datasource.TextST class 940 are getLanguage( ) 941 and getstyle( ) 942, and functions of the APIs are defined as shown in Table 4.

TABLE 4
Class name: org.blu-ray.datasource.TextST

| | |
|---|---|
| getLanguage( ); | Fetch a language of a current text subtitle |
| getStyle( ); | Fetch style information of a current text substitle |

FIG. 10 is a diagram illustrating a detailed structure of the extended media package unit 620 shown in FIG. 8 according to an embodiment of the present invention.

Referring to FIG. 10, a package name of the extended media package is org.blu-ray.media 1000, and class names of classes in the extended media package are org.blu-ray.media.Player 1010, org.blu-ray.media.Manager 1020, and org.blu-ray.media.MediaLocator 1030.

The org.blu-ray.media.Player class 1010 reproduces moving picture data, that is, a playlist, containing moving picture data information and playback unit information, stops and resumes the playback, or stops a screen while performing the playback. APIs included in the org.blu-ray.media.Player class 1010 are Play( ) 1011, pauseOn( ) 1012, pauseOff( ) 1013, and stillOff( ) 1014, and functions of the APIs are defined as shown in Table 5.

TABLE 5
Class name: org.blu-ray.media.Player

| | |
|---|---|
| Play( ); | Perform a playback |
| pauseOn( ); | Stop a playback |
| pauseOff( ); | Resume a stopped playback |
| stillOff( ); | Stop a screen while performing a playback |

The org.blu-ray.media.Manager class 1020 generates a mediasource and player based on reproducing unit data, such as a playlist to be reproduced in the extended JMF. APIs included in the org.blu-ray.media.Manager class 1020 are createPlayerPL(PlayList pi) 1021, createPlayerPLAtPlayItem(PlayList pi, PlayItem pi) 1022, createPlayerPLAtMark(PlayList pi, PlayListMark mark) 1023, createPlayerPLAtSpecifiedItem(PlayList pi, Time t) 1024, skipToNextPoint( ) 1025, skipBackToPrevPoint( ) 1026, and TerminatePlayList( ) 1027, and functions of the APIs are defined as shown in Table 6.

TABLE 6
Class name: org.blu-ray.media.Manager

| | |
|---|---|
| createPlayerPL(PlayList pl); | Prepare to reproduce a specific |
| | playlist (perform a playback |
| | from the first of the playlist) |
| createPlayerPLAtPlayItem(PlayList pl, | Prepare to perform a playback |
| PlayItem pi); | from a specific playitem of a |
| | specific playlist |
| createPlayerPLAtMark(PlayList pl, | Prepare to perform a playback |
| PlayListMark mark); | from a specific mark of a |
| | specific playlist |
| createPlayerPLAtSpecifiedItem(PlayList | Prepare to perform a playback |
| pl, Time t); | from a specific time of a specific |
| | playlist |
| skipToNextPoint( ); | Change a playback point to a |
| | next mark point |
| skipBackToPrevPoint( ); | Change a playback point |
| | to a previous mark point |
| TerminatePlayList( ); | Forcibly terminate a playback |
| | of a playlist |

The org.blu-ray.media.MediaLocator class 1030 reads file information in a disk, a memory, or a database and finds a corresponding file.

TABLE 7
Class name: org.blu-ray.media.MediaLocator class

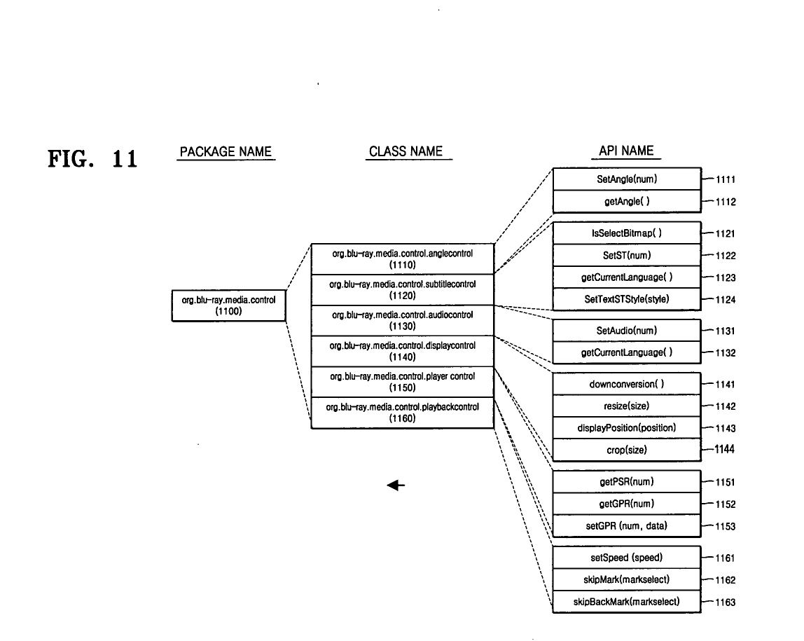

FIG. 11 is a diagram illustrating a detailed structure of the extended control package unit 630 shown in FIG. 8 according to an embodiment of the present invention.

Referring to FIG. 11, a package name of the extended control package is org.blu-ray.media.control 1100, and class names of classes included in the extended control package are org.blu-ray.media.control.anglecontrol 1110, org.blu-ray.media.control.subtitlecontrol 1120, org.blu-ray.media.control.audiocontrol 1130, org.blu-ray.media.control.displaycontrol 1140, org.blu-ray.media.control.playercontrol 1150, and org.blu-ray.media.control.playbackcontrol 1160.

The org.blu-ray.media.control.anglecontrol class 1110 changes an angle to show a moving picture, which has been taken by several cameras at the same time, according to a user's selection. APIs included in the org.blu-ray.media.control.anglecontrol class 1110 are SetAngle(num) 1111 and getAngle( ) 1112, and functions of the APIs are defined as shown in Table 8.

TABLE 8
Class name: org.blu-ray.media.control.anglecontrol
(angle control: changing angle according to user selection.

| | |
|---|---|
| SetAngle(num); | Make a change to a specific angle |
| getAngle( ); | Fetch current angle information |

The org.blu-ray.media.control.subtitlecontrol class 1120 changes a subtitle to select a subtitle style (a text subtitle or a bitmap subtitle) or a language. APIs included in the org.blu-ray.media.control.subtitlecontrol class 1120 are IsSelectBitmap( ) 1121, SetST(num) 1122, getCurrentLanguage( ) 1123, and SetTextSTStyle(style) 1124, and functions of the APIs are defined as shown in Table 9.

TABLE 9
Class name: org.blu-ray.media.control.subtitlecontrol
(subtitle control: selecting bitmap or text subtitle, changing
subtitle to other language and presenting subtitle)

| | |
|---|---|
| IsSelectBitmap( ); | Ascertain whether a bitmap subtitle is used (a |
| | subtitle is divided into a text subtitle and a |
| | bitmap subtitle) |
| SetST(num); | Make a change to a specific subtitle |
| getCurrentLanguage( ); | Fetch current subtitle language information |
| SetTextSTStyle(style); | Change a text subtitle to a specific style |

The org.blu-ray.media.control.audiocontrol class 1130 changes an audio setting to select audio in moving picture data according to a language. APIs included in the org.blu-ray.media.control.audiocontrol class 1130 are setAudio(num) 1131 and getCurrentLanguage( ) 1132, and functions of the APIs are defined as shown in Table 10.

TABLE 10
Class name: org.blu-ray.media.control.audiocontrol
(audio control: changing audio to other language

| | |
|---|---|
| setAudio(num); | Make a change to a specific audio |
| getCurrentLanguage( ); | Fetch current audio information |

The org.blu-ray.media.control.displaycontrol class 1140 changes a size or a position of a screen on which moving picture data is displayed. APIs included in the org.blu-ray.media.control.displaycontrol class 1140 are downconversion( ) 1141, resize(size) 1142, displayPosition(position) 1143, and crop(size) 1144, and functions of the APIs are defined as shown in Table 11.

TABLE 11
Class name: org.blu-ray.media.control.displaycontrol
(display control: down-conversion and resizing window)

| | |
|---|---|
| downconversion( ); | Change a resolution of a screen |
| resize(size); | Change a size of a screen |
| displayPosition(position); | Change a screen to a specific position |
| crop(size); | Display a part of a screen |

The org.blu-ray.media.control.playercontrol class 1150 reads or stores a register value in the reproducing apparatus. APIs included in the org.blu-ray.media.control.playercontrol class 1150 are getPSR(num) 1151, getGPR(num) 1152, and setGPR(num,data) 1153, and functions of the APIs are defined as shown in Table 12.

Table 12

Class name: org.blu-ray.media.control.playercontrol
(player register control: modify and update player status registers (PSRs),
general purpose registers (GPRs)

| | |
|---|---|
| getPSR(num); | Fetch PSR information |
| getGPR(num) 1152; | Fetch GPR information |
| setGPR(num, data); | Change a specific GPR value |

The org.blu-ray.media.control.playbackcontrol class 1160 changes a playback point of moving picture data to predefined points of the moving picture data at predetermined intervals or for specific purposes, or changes a playback speed of the moving picture data. APIs included in the org.blu-ray.media.control.playbackcontrol class 1160 are setSpeed(speed) 1161, skipMark(markselect) 1162, and skipBackMark(markselect) 1163, and functions of the APIs are defined as shown in Table 13.

TABLE 13
Class name: org.blu-ray.media.control.playbackcontrol
(playback control: fast/slow forward/backward playback, skip mark,
back-skip mark)

| | |
|---|---|
| setSpeed(speed); | Change a playback speed |
| skipMark(markselect); | Change a playback point to a subsequent |
| | specific mark |
| skipBackMark(markselect); | Change a playback point to a preceding |
| | specific mark |

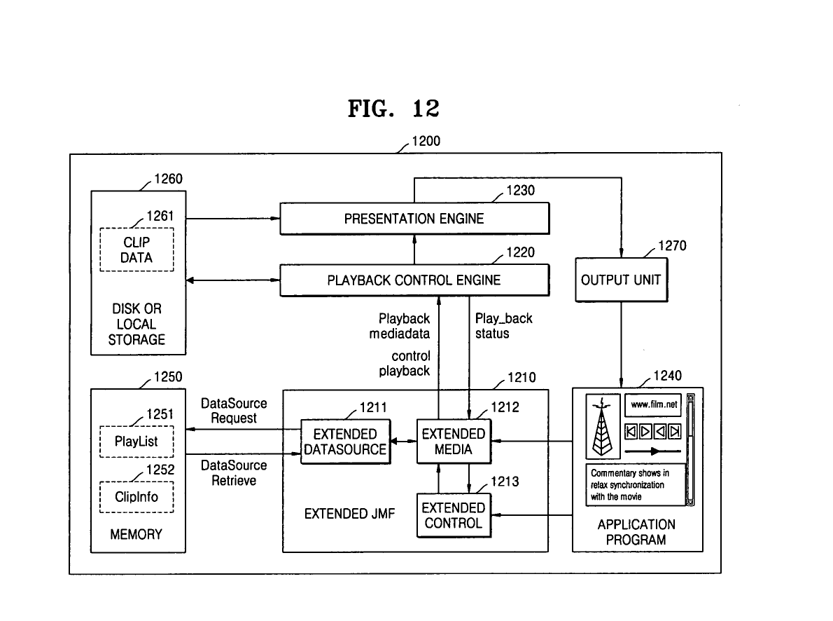

FIG. 12 is a schematic diagram of a reproducing apparatus including an extended JMF according to an embodiment of the present invention.

Referring to FIG. 12, a reproducing apparatus 1200 includes an extended JMF 1210, a playback control engine 1220, a presentation engine 1230, an application program 1240, a memory 1250, a disk or local storage 1260, and a video/audio output unit 1270.

The application program 1240 receives a user input related to a moving picture data playback request or a moving picture data playback control request, and transmits the moving picture data playback request to an extended media 1212 and the moving picture data playback control request to an extended control 1213.

The extended media 1212 receives the moving picture data playback request from the application program 1240 and controls an extended datasource 1211 to read playback information of moving picture data to be reproduced, and receives the playback information of the moving picture data from the extended datasource 1211 and controls the playback control engine 1220 to reproduce the moving picture data based on the playback information. Further, the extended media 1212 receives control information from the extended control 1213 and controls the playback control engine 1220 to reproduce the moving picture data based on the control information, and receives control status information from the playback control engine 1220 and transmits the control status information to the extended control 1213.

The extended datasource 1211 receives instructions from the extended media 1212, reads the playback information of the moving picture data, that is, playlist data 1251 and clipinfo data 1252, from the memory 1250, and transmits the read data to the extended media 1212.

The extended control 1213 receives the moving picture data playback control request from the application program 1240 providing, for example, a graphical user interface (GUI), parses the moving picture data playback control request, and transmits the parsed control result to the extended media 1212.

The playback control engine 1220 receives a moving picture data playback command or a moving picture data playback control command from the extended media 1212, and controls the presentation engine 1230 to reproduce and output the moving picture data. Further, the playback control engine 1220 transmits the playback command result or control status information, such as an event occurring during the playback, to the extended media 1212.

The presentation engine 1230 reads and reproduces clip AV stream data from the disk or local memory 1260 according to a control signal of the playback control engine 1220. The reproduced data is output to the output unit 1270.

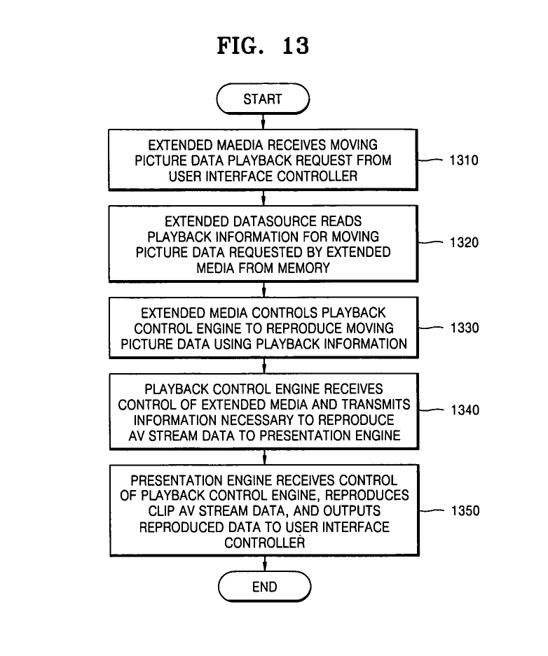

FIG. 13 is a flowchart illustrating a method of reproducing moving picture data in the reproducing apparatus including the extended JMF according to an embodiment of the present invention.

Referring to FIG. 13, in operation 1310, the extended media 1212 receives a moving picture data playback request from the application program 1240. The extended media 1212 controls the extended datasource 1211 to obtain playback information of the moving picture data requested to be reproduced.

In operation 1320, the extended datasource reads the playback information for the moving picture data requested by the extended media 1212 from the memory 1250. The playback information includes playlist data 1251 and clipinfo data 1252.

Next, in operation 1330, the extended media 1212 receives the playback information read by the extended datasource 1211, and controls the playback control engine 1220 to reproduce the moving picture data using the playback information.

Then, in operation 1340, the playback control engine 1220 receives first control information from the extended media 1212, and transmits information necessary to reproduce AV stream data to the presentation engine 1230.

In operation 1350, the presentation engine 1230 receives second control information from the playback control engine 1220, reproduces the clip AV stream data, and outputs the reproduced data to the output unit 1270.

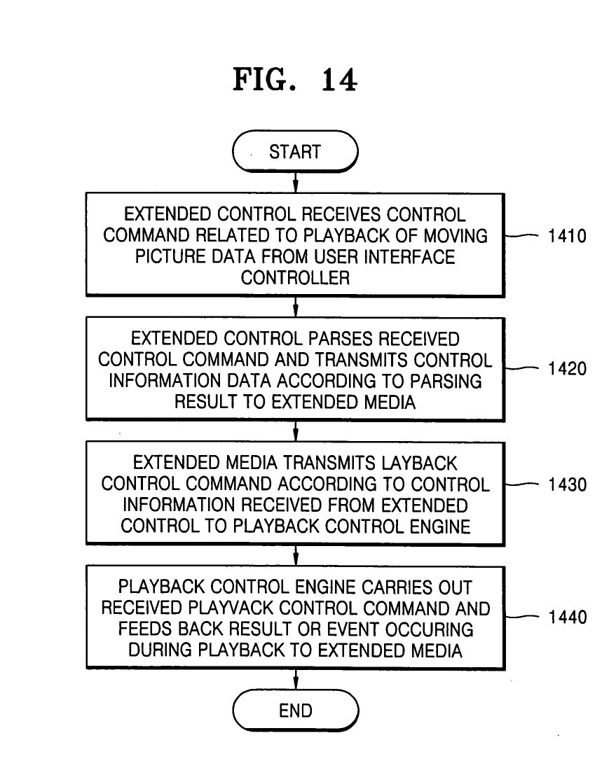

FIG. 14 is a flow chart illustrating a method of controlling the playback of the moving picture data in the reproducing apparatus including the extended JMF according to another embodiment of the present invention.

In operation 1410, the extended control 1213 receives a control command related to the playback of moving picture data from the application program 1240.

In operation 1420, the extended control 1213 parses the received control command, and transmits control information according to the parsing result to the extended media 1212.

In operation 1430, the extended media 1212 transmits a playback control command according to the control information received from the extended control 1213 to the playback control engine 1220.

In operation 1440, the playback control engine 1220 carries out the received playback control command, and feeds back the result or status information, such as an event occurring during the playback, to the extended media 1212. The extended media 1212 may manage the received status information and transmit the managed status information to the extended control 1213.

The present invention may be embodied in a code program, which can be read by a computer, on a computer readable recording medium. The computer readable recording medium includes all kinds of recording apparatuses on which computer readable data are stored. The computer readable recording media includes storage media such as magnetic storage media (e.g., ROM's, floppy disks, hard disks, etc.), optically readable media (e.g., CD-ROMs, DVDs, etc.) and carrier waves (e.g., transmissions over the Internet). Also, the computer readable recording media can be stored on computer systems connected through a network and executed in a distributed mode.

As described above, the reproducing apparatus is independent of a platform such that it can be easily applied to various platforms in reproducing moving picture data including AV data and playback information of the AV data.

Although a few embodiments of the present invention have been shown and described, it would be appreciated by those skilled in the art that changes may be made in these embodiments without departing from the principles and spirit of the invention, the scope of which is defined in the claims and their equivalents.

1. A reproducing apparatus, comprising:
an extended Java Media Framework to control a playback of moving picture data that includes audio/video (AV) data and playback information of the AV data.

2. The reproducing apparatus of claim 1, wherein the extended Java Media Framework comprises at least one of:
a datasource package unit, which parses the playback information of the AV data and transmits the parsed playback information to a media package unit;
the media package unit, which controls the playback of the moving picture data according to the playback information received from the datasource package; or
a control package unit, which controls additional functions providable in relation to the playback of the moving picture data.

3. The reproducing apparatus of claim 2, wherein the datasource package unit comprises at least one of:
a playlist class, which fetches information from a playlist;
a playitem class, which fetches information from a playitem in the playlist;
a clipinfo class, which fetches information from a clipinfo; or
a text subtitle class, which fetches information regarding a text subtitle.

4. The reproducing apparatus of claim 3, wherein the playlist class comprises at least one of:
a first application program interface (API) function, which fetches a number of playitems from the playlist;
a second API function, which fetches a specific playitem from the playlist;
a third API function, which fetches a specific mark from the playlist; or
a fourth API function, which fetches the number of playitems from the playlist.

5. The reproducing apparatus of claim 3, wherein the playitem class comprises at least one of:
a first API function, which ascertains whether multiangles are in the number of playitems;
a second API function, which fetches the number of multiangles; or
a third API function, which fetches a clipinfo file name corresponding to a specific multiangle.

6. The reproducing apparatus of claim 3, wherein the clipinfo class comprises at least one of:
a first API function, which fetches a name of a corresponding clip file;
a second API function, which fetches a language of a current audio; or
a third API function, which fetches a language of a current subtitle.

7. The reproducing apparatus of claim 3, wherein the text subtitle class comprises at least one of:
a first API function, which fetches a language of a current text subtitle; or
a second API function, which fetches style information of a current text subtitle.

8. The reproducing apparatus of claim 2, wherein the media package comprises at least one of:
a player class, which controls the playback of the moving picture data;
a manager class, which generates and manages a mediasource and player class; or
a media locator class, which finds a position of a data file.

9. The reproducing apparatus of claim 8, wherein the player class comprises at least one of:
a first API function, which commands a playback;
a second API function, which commands to stop a playback;
a third API function, which commands to resume a stopped playback; or
a fourth API function, which commands to stop a screen while performing a playback.

10. The reproducing apparatus of claim 8, wherein the manager class comprises at least one of:
a first API function, which prepares a specific playlist for reproduction;
a second API function, which prepares to perform a playback from a specific playitem of a specific playlist;
a third API function, which prepares to perform the playback from a specific mark of the specific playlist;
a fourth API function, which prepares to perform the playback from a specific time of the specific playlist;
a fifth API function, which changes a playback point to a next mark point;
a sixth API function, which changes the playback point to a previous mark point; or
a seventh API function, which forcibly terminates the playback of the specific playlist.

11. The reproducing apparatus of claim 2, wherein the control package comprises at least one of:
an angle control class, which controls an angle;
a subtitle control class, which controls a subtitle;
an audio control class, which controls audio;
a display control class, which controls a display;
a player control class, which controls a player; or
a playback control class, which controls a playback.

12. The reproducing apparatus of claim 11, wherein the angle control class comprises at least one of:
a first API function, which makes a change to a specific angle; or
a second API function, which fetches current angle information.

13. The reproducing apparatus of claim 11, wherein the subtitle control class comprises at least one of:
a first API function, which ascertains whether a bitmap subtitle is used;
a second API function, which makes a change to a specific subtitle;
a third API function, which fetches current subtitle language information; or
a fourth API function, which changes a style of a text subtitle to a specific style.

14. The reproducing apparatus of claim 11, wherein the audio control class comprises at least one of:
a first API function, which makes a change to a specific audio; or
a second API function, which fetches current audio information.

15. The reproducing apparatus of claim 11, wherein the display control class comprises at least one of:
a first API function, which changes a resolution of a screen;
a second API function, which changes a size of the screen;
a third API function, which changes a position of the screen to a specific position; or
a fourth API function, which displays a part of the screen.

16. The reproducing apparatus of claim 11, wherein the player control class comprises at least one of:
a first API function, which fetches player status register information;
a second API function, which fetches general purpose register information; or
a third API function, which changes a specific player status register value.

17. The reproducing apparatus of claim 11, wherein the playback control class comprises at least one of:
a first API function, which changes a playback speed;
a second API function, which changes a playback point to a preceding specific mark; or
a third API function, which changes the playback point to a subsequent specific mark.

18. The reproducing apparatus of claim 1, further comprising:
a playback control engine, which controls reproduction of the moving picture data according to a control of the Java Media Framework; and
a presentation engine, which reproduces the moving picture data according to the control of the playback control engine.

19. A reproducing method, comprising:
controlling a playback of moving picture data, which includes audio/video (AV) data and playback information of the AV data, using an extended Java Media Framework inheriting a Java Media Framework structure.

20. The method of claim 19, wherein the controlling of the playback comprises:
parsing the playback information of the moving picture data;
controlling the playback of the moving picture data according to the parsed playback information; and
controlling additional functions providable in relation to the playback of the moving picture data.

21. The method of claim 20, wherein the parsing of the playback information comprises at least one of:
fetching information from a playlist;
fetching information from a playitem;
fetching information from a clipinfo; or
fetching information regarding a text subtitle.

22. The method of claim 21, wherein the fetching of the information from the playlist comprises at least one of:
fetching the number of playitems from the playlist;
fetching a specific playitem from the playlist;
fetching a specific mark from the playlist; or
fetching the number of marks from the playlist.

23. The method of claim 21, wherein the fetching of the information from the playitem comprises at least one of:
ascertaining whether multiangles are in the playitem;
fetching the number of multiangles; or
fetching a clipinfo file name corresponding to a specific multiangle.

24. The method of claim 21, wherein the fetching of the information from the clipinfo comprises at least one of:
fetching a name of a corresponding clip file;
fetching a language of a current audio; or
fetching a language of a current subtitle.

25. The method of claim 21, wherein the fetching of the information regarding the text subtitle comprises at least one of:
fetching a language of a current text subtitle; or
fetching style information of a current text subtitle.

26. The method of claim 20, wherein the controlling of the playback of the moving picture data comprises at least one of:
controlling the playback of the moving picture data;
generating and managing a mediasource and player class; or
finding a position of a data file.

27. The method of claim 26, wherein the controlling of the playback of the moving picture data comprises at least one of:
commanding to perform a playback;
commanding to stop the playback;
commanding to resume the stopped playback; or
commanding to stop a screen while performing the playback.

28. The method of claim 26, wherein the generating and managing of the mediasource and player class comprises at least one of:
preparing to reproduce a specific playlist;
preparing to perform a playback from a specific playitem of the specific playlist;
preparing to perform the playback from a specific mark of the specific playlist;
preparing to perform the playback from a specific time of the specific playlist;
changing a playback point to a next mark point;
changing the playback point to a previous mark point; and
forcibly terminating the playback of the specific playlist.

29. The method of claim 20, wherein the controlling of the additional functions comprises at least one of:
controlling an angle;
controlling a subtitle;
controlling audio;
controlling a display;
controlling a player; or
controlling a playback.

30. The method of claim 29, wherein the controlling of the angle comprises at least one of:
making a change to a specific angle; or
fetching current angle information.

31. The method of claim 29, wherein the controlling of the subtitle comprises at least one of:
ascertaining whether a bitmap subtitle is used;
making a change to a specific subtitle;
fetching current subtitle language information; or
changing a style of a text subtitle to a specific style.

32. The method of claim 29, wherein the controlling of the audio comprises at least one of:
making a change to a specific audio; or
fetching current audio information.

33. The method of claim 29, wherein the controlling of the display comprises at least one of:
changing a resolution of a screen;
changing a size of the screen;
changing a position of the screen to a specific position; or
displaying a part of the screen.

34. The method of claim 29, wherein the controlling of the player comprises at least one of:
fetching player status register information;
fetching general purpose register information; or
changing a specific player status register value.

35. The method of claim 29, wherein the controlling of the playback comprises at least one of:
changing a playback speed;
changing a playback point to a preceding specific mark; or
changing the playback point to a subsequent specific mark.

36. A computer readable recording medium having embodied thereon a computer program for executing a reproducing method, the method comprising:
controlling a playback of moving picture data, which includes AV data and playback information of the audio/video (AV) data, using an extended Java Media Framework inheriting a Java Media Framework structure.

37. An apparatus for controlling the reproduction of moving picture data, the moving picture data including audio/video (AV) data and playback information corresponding to the AV data, comprising:
a datasource packager parsing the playback information corresponding to the AV data; and
a media packager controlling the reproducing of the AV data according to the parsed playback information.

38. The apparatus of claim 37, wherein the datasource packager and the media packager comprise a Java Media Framework.

39. The apparatus of claim 37, wherein the reproducing of the AV data according to the parsed playback information is independent of a type of computer platform.

40. The apparatus of claim 37, further comprising:
a controller selecting at least one additional playback function corresponding to the reproducing of the AV data.

41. The apparatus of claim 40, wherein the at least one additional playback function comprises a camera angle view of the reproducing of the AV data, a subtitle style or language of the reproducing of the AV data, an audio setting corresponding to the reproducing of the AV data, display settings of the reproducing of the AV data, register values corresponding to the reproducing of the AV data, a rate of the reproducing of the AV data, or a reproduction point of the reproducing of the AV data.

42. A method of controlling the reproducing of moving picture data, the moving picture data including audio/video (AV) data and playback information corresponding to the AV data, comprising:
parsing the playback information corresponding to the AV data; and
reproducing of the AV data according to the parsed playback information according to a Java Media Framework structure.

43. The method of claim 42, wherein the reproducing of the AV data according to the parsed playback information is independent of a type of reproducing platform.
